(19) United States
(12) Patent Application Publication
(10) Pub. No.: US 2015/0162731 A1
(43) Pub. Date: Jun. 11, 2015

(54) ELECTRIC-WIRE PROTECTION PIPE AND WIRE HARNESS

(71) Applicants: AUTONETWORKS TECHNOLOGIES, LTD., Yokkaichi, Mie (JP); SUMITOMO WIRING SYSTEMS, LTD., Yokkaichi, Mie (JP); SUMITOMO ELECTRIC INDUSTRIES, LTD., Osaka-shi, Osaka (JP)

(72) Inventors: Yuichi Kimoto, Yokkaichi (JP); Fujio Sonoda, Yokkaichi (JP); Yasushi Itani, Yokkaichi (JP); Naoki Aoyama, Yokkaichi (JP); Yoshinori Sugimoto, Yokkaichi (JP)

(73) Assignees: AUTONETWORKS TECHNOLOGIES, LTD., Yokkaichi, Mie (JP); SUMITOMO WIRING SYSTEMS, LTD., Yokkaichi, Mie (JP); SUMITOMO ELECTRIC INDUSTRIES, LTD., Osaka-shi, Osaka (JP)

(21) Appl. No.: 14/399,056

(22) PCT Filed: Apr. 30, 2013
(86) PCT No.: PCT/JP2013/062580

§ 371 Date: Nov. 5, 2014

(30) Foreign Application Priority Data
May 16, 2012 (JP) 2012-112540

(51) Int. Cl. H02G 3/04; B60R 16/02

(52) U.S. Cl. CPC H02G 3/0481; B60R 16/0215

(57) ABSTRACT

An electric-wire protection pipe includes a tubular main portion that that constitutes an outer wall of the electric-wire protection pipe and that has a longitudinal axis, wherein a reference plane passes through the longitudinal axis in a first direction. A curved partition wall partitions a hollow portion of the tubular main portion into two wiring paths—one on the first direction side and the other on a second direction side opposite to the first direction side. The curved partition wall connects to the tubular main portion at border lines that are parallel to the longitudinal axis and are located on the first direction side of the longitudinal axis, the curved partition wall having a convex side that projects in a second direction opposite to the first direction.

This application is a national stage application of PCT/JP2013/062580, international filing date Apr. 30, 2013, and claims priority to JP 2012-112540, filed in Japan on May 16, 2012, the entire disclosures of which are hereby incorporated by reference.

### BACKGROUND

The present invention relates to an electric-wire protection pipe that is made of metal and forms a wiring path through which insulated electric wires pass, and a wire harness including the same.

Conventionally, a wire harness mounted to a vehicle sometimes includes an electric-wire protection pipe that is a tubular metal member surrounding insulated electric wires as described in JP 2004-171952A, for example. The electric-wire protection pipe is (i) a member that mechanically protects the insulated electric wires as well as (ii) an electromagnetic shielding member that shields from electromagnetic noise waves. Therefore, the insulated electric wires that pass through the electric-wire protection pipe are non-shielded-type electric wires including no shielding members such as a braided wire.

Moreover, JP 2011-146228A proposes to use an electric-wire protection pipe provided with a partition wall thereinside. The hollow portion of the electric-wire protection pipe described in JP 2011-146228A is partitioned into a plurality of wiring paths by the partition wall.

When the electric-wire protection pipe provided with the partition wall thereinside is used, even if a plurality of types of insulated electric wires pass through one electric-wire protection pipe, it is possible to prevent the influences of electromagnetic noise between different types of insulated electric wires without using electric wires having a shielding member. That is, such an electric-wire protection pipe is provided with a plurality of wiring paths that each have a shielding function thereinside.

For example, insulated electric wires for a power system and insulated electric wires for a low-current system may pass through separate wiring paths partitioned by the partition wall, and thereby, it is possible to prevent the electromagnetic noise from the insulated electric wires for the power system from influencing the insulated electric wires for the low-current system.

### SUMMARY

Incidentally, the partition wall of the electric-wire protection pipe described in JP 2011-146228A has a cross-section with a curved shape or a crooked shape, and therefore, the electric-wire protection pipe is easy to bend. For example, in the examples shown in FIGS. 1 and 3 of JP 2011-146228A, a partition wall having a cross-section with a zigzag shape passes an axis (centerline) of a cylindrical main portion and partitions the hollow portion of the main portion into two equal portions. Thereby, the hollow portion of the electric-wire protection pipe is provided with two wiring paths with the same shape.

The electric-wire protection pipe shown in FIGS. 1 and 3 of JP 2011-146228A is easily bent so that one of a pair of border lines formed by portions in which the cylindrical main portion and the zigzag partition wall are connected to each other is an inner edge and the other is an outer edge. In this case, at the bent portion of the electric-wire protection pipe, the main portion is deformed into a flattened shape in which a dimension in a bending direction is reduced, and the zigzag partition wall is contracted in a direction of the diameter of the main portion in the same manner as a plate with a bellows shape is contracted. Therefore, even at the bent portion, the two wiring paths have cross-sections with substantially the same shape.

However, if the zigzag partition wall described in JP 2011-146228A were provided so as not to pass the axis of the tubular main portion, it is difficult to predict how the partition wall would be deformed at the bent portion of the electric-wire protection pipe. Therefore, there is a possibility that the balance between the cross-sectional areas of the two wiring paths with shapes different from each other would be significantly changed at the bent portion, one wiring path would become extremely small, and then the partition wall would press against the insulated electric wires. Accordingly, when it is desired to partition the hollow portion of the electric-wire protection pipe to be bent into two wiring paths that have cross-sections with shapes different from each other, the zigzag partition wall described in JP 2011-146228A is not suitable.

It is an object of the present invention that while the ease of bending processing is secured in the electric-wire protection pipe provided with two wiring paths having a shielding function thereinside, it is possible to prevent the balance between the cross-sectional areas of the two wiring paths with is shapes different from each other from being significantly changed at the bent portion.

A wire harness according to a first aspect of the present invention comprises a plurality of insulated electric wires, and an electric-wire protection pipe through which the insulated electric wires pass. The electric-wire protection pipe comprises (i) a tubular main portion that constitutes an outer wall of the electric-wire protection pipe and that has a longitudinal axis, wherein a reference plane passes through the longitudinal axis in a first direction, and (ii) a curved partition wall that connects to the tubular main portion at border lines that are parallel to the longitudinal axis and are located on the first direction side of the longitudinal axis. The curved partition wall has a convex side that projects in a second direction opposite to the first direction. Furthermore, the curved partition wall partitions a hollow portion of the tubular main portion into a first wiring path on the first direction side and a second wiring path on the second direction side. Additionally, the electric-wire protection pipe has a bent portion that is bent along the reference plane.

The curved partition wall of the electric-wire protection pipe may have symmetry with respect to the reference plane.

A mark may be formed at one or both portions along a line on which the outer side surface of the tubular main portion and the reference plane intersect with each other.

In another aspect, the present invention provides an electric-wire protection pipe comprising the tubular main portion and the curved partition wall as described above.

In the structures described above, making the tubular main portion and the curved partition wall of metal allows the electric-wire protection pipe to be provided with the first wiring path and the second wiring path that are each surrounded by conductive walls and thus have a shielding function. Moreover, the two wiring paths have shapes different from each other.

In the structures described above, when being bent along the reference plane that passes the axis of the tubular main portion in the first direction, the tubular main portion and the curved partition wall that constitute the electric-wire protection pipe have no corner portions serving as reinforced portions in the bending direction. Therefore, the tubular main portion and the curved partition wall have shapes that are easy to bend along the reference plane.

Moreover, when the electric-wire protection pipe is bent along the reference plane, the tubular main portion is deformed around the axis as substantially a center, and has a cross-section with a flattened shape. At that time, in the tubular main portion, a first width dimension in the first direction and the second direction is reduced, and a second width dimension in a direction orthogonal to the axis of the tubular main portion and the first direction is increased. At the same time, the curved partition wall is deformed, reducing its curvature by following the increase in the second width dimension of the tubular main portion. That is, the curved partition wall has a structure in which the tubular main portion is unlikely to be prevented from being bent along the reference plane.

Furthermore, when the curvature of the curved partition wall is reduced and the tubular main portion is caused to have a flattened shape by bending the electric-wire protection pipe along the reference plane, the cross-sectional shapes of the two wiring paths become slightly flattened, but the balance of the cross-sectional areas thereof is not significantly changed.

Accordingly, by using the wire harness according to the structures described above, while the ease of bending processing is secured in the electric-wire protection pipe provided with two wiring paths having a shielding function thereinside, it is possible to prevent the balance between the cross-sectional areas of the two wiring paths with shapes different from each other from being significantly changed at the bent portion.

Moreover, when the curved partition wall of the electric-wire protection pipe has symmetry with respect to the reference plane as described above, the balance between the cross-sectional areas of the two wiring paths with shapes different from each other is further prevented from being changed.

Furthermore, when marks are formed at portions along the lines on which the outer side surface of the tubular main portion and the reference plane intersect with each other as described above, the direction suitable for bending the electric-wire protection pipe can be easily confirmed.

### BRIEF DESCRIPTION OF THE DRAWINGS

FIG. 1 is a perspective view of an electric-wire protection pipe 1 according to an embodiment of the present invention.

FIG. 2 is a cross-sectional view of the electric-wire protection pipe 1.

FIGS. 3A and 3B are a first orthographic view and a second orthographic view, respectively, of the electric-wire protection pipe 1.

FIG. 4 is a perspective view of a wire harness 10 according to an embodiment of the present invention.

FIG. 5 is a cross-sectional view of a straight pipe portion of the wire harness 10.

FIG. 6 is a cross-sectional view of a bent portion of the wire harness 10.

### DETAILED DESCRIPTION OF EMBODIMENTS

Hereinafter, embodiments of the present invention will be described with reference to the attached drawings. The following embodiments are merely specific examples of the present invention, and are not to restrict the technical scope of the present invention.

Electric-Wire Protection Pipe

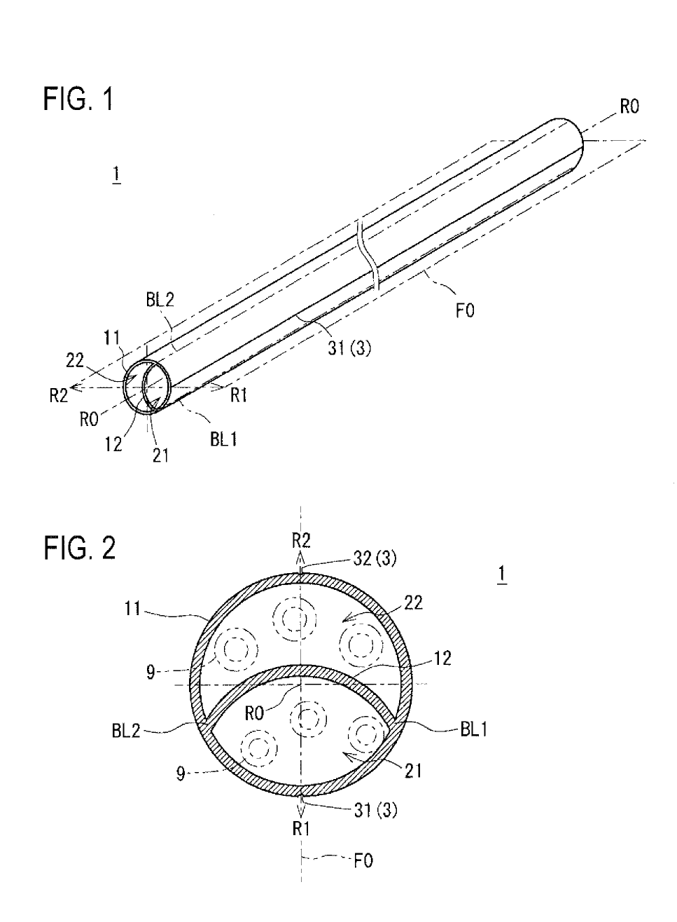

First, a configuration of an electric-wire protection pipe 1 will be described with reference to FIGS. 1 to 3. The electric-wire protection pipe 1 is a metal pipe provided with two wiring paths 21 and 22 thereinside through which insulated electric wires 9 pass. It should be noted that in FIG. 2, the insulated electric wires 9 are drawn by phantom lines (long dashed/double-short dashed lines).

It is conceivable that the electric-wire protection pipe 1 is a tubular member made from a material containing aluminum, stainless steel, or the like as a main component. Moreover, it is conceivable that a plating layer or a paint layer is formed on the outer surface of the electric-wire protection pipe 1 as needed.

As shown in FIGS. 1 and 2, the electric-wire protection pipe 1 has a tubular main portion 11 and a curved partition wall 12. The tubular main portion 11 constitutes the outer wall of the electric-wire protection pipe 1. Moreover, the tubular main portion 11 is formed so that the cross-section orthogonal to a longitudinal direction of the electric-wire protection pipe 1 has a curved annular shape. In the examples shown in FIGS. 1 and 2, the tubular main portion 11 has a cylindrical shape.

In FIGS. 1 to 3, a longitudinal axis R0 of the tubular main portion 11 is drawn by long dashed/short dashed lines. The axis R0 is a centerline of the tubular main portion 11. Also, in FIGS. 1 to 3, a first direction 111 orthogonal to the axis R0 and a second direction R2 opposite to the first direction R1 are drawn by long dashed/short dashed lines with an arrow. Furthermore, in

FIGS. 1 and 2, a reference plane F0 that passes the axis R0 in the first direction R1 is also drawn by long dashed/short dashed lines.

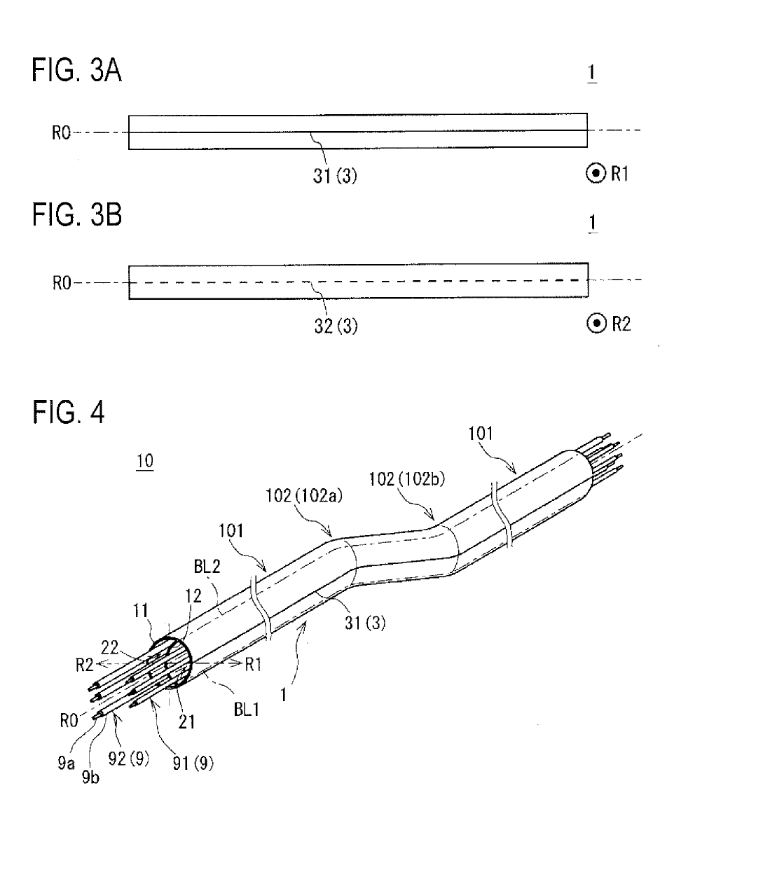

It should be noted that FIGS. 2, 5 and 6 each show a cross-section orthogonal to the axis R0. Moreover, FIG. 3A is an orthographic drawing of the electric-wire protection pipe 1 as viewed from the first direction R1. Furthermore, FIG. 3B is an orthographic drawing of the electric-wire protection pipe 1 as viewed from the second direction R2.

The curved partition wall 12 partitions the hollow portion of the tubular main portion 11 into a first wiring path 21 on the first direction R1 side and a second wiring path 22 on the second direction R2 side. The curved partition wall 12 connects to the tubular main portion 11 at border lines BL1 and BL2 that are located so as to be shifted to the first direction R1 side with respect to the axis R0 on the inner side surface of the tubular main portion 11.

The more the border lines BL1 and BL2, which are respective end portions of the curved partition wall 12, are shifted to the first direction R1 side, the larger a ratio of the cross-sectional area of the second wiring path 22 to the cross-sectional area of the first wiring path 21 becomes.

Furthermore, the entire cross-section of the curved partition wall 12 orthogonal to the axis R0 is curved, and the convex side of the curve projects in the second direction R2. In the examples shown in FIGS. 1 and 2, the cross-section, orthogonal to the axis R0, of the curved partition wall 12 has an arc shape, the convex side of which projects in the second direction R2.

Moreover, in this embodiment, the curved partition wall 12 has symmetry with respect to the reference plane F0. Accordingly, the pair of border lines BL1 and BL2 also has symmetry with respect to the reference plane F0. The electric-wire protection pipe 1 is formed by, for example, drawing processing or extrusion processing.

Moreover, in the examples shown in FIGS. 1 to 3, the tubular main portion 11 has a uniform thickness. In the same manner, the curved partition wall 12 also has a uniform thickness.

As shown in FIGS. 1 to 3, marks 3 are formed at portions along the lines on which the outer side surface of the tubular main portion 11 and the reference plane F0 intersect with each other. In the example shown in FIG. 2, the marks 3 are formed in a groove shape by cutting the outer side surface of the tubular main portion 11. It should be noted that it is also conceivable to place the marks 3 using paint or the like.

In the example shown in FIG. 3, of the portions at the two places at which the outer side surface of the tubular main portion 11 and the reference plane F0 intersect with each other, a first mark 31 formed at an end surface portion on the first direction R1 side and a second mark 32 formed at an end surface portion on the second direction R2 side have patterns different from each other. For example, one of the first mark 31 and the second mark 32 may be indicated by a solid line and the other may be indicated by a broken line. It should be noted that one of the first mark 31 and the second mark 32 may be omitted.

Although the electric-wire protection pipe 1 shown in FIG. 1 is a straight pipe, when being provided as a portion of a wire harness, the electric-wire protection pipe 1 is provided in a state where it has been bent.

Wire Harness

Next, a wire harness 10 according to an embodiment of the present invention will be described with reference to FIGS. 4 to 6. The wire harness 10 includes the plurality of insulated electric wires 9 and the electric-wire protection pipe 1 with the hollow portion through which the insulated electric wires 9 pass.

The insulated electric wires 9 are each constituted by a core wire 9a that is made of a conductive material and an insulating coating 9b that is made of an insulating material and surrounds the core wire 9a. The end portion of the insulated electric wires 9 is often provided with a terminal fitting or a connector (not shown).

Moreover, the electric-wire protection pipe 1 included in the wire harness 10 has at least one bent portion 102 that has been bent along the reference plane F0. That is, in the wire harness 10, the electric-wire protection pipe 1 is constituted by a straight pipe portion 101 that has not been bent and the bent portion 102 that has been bent.

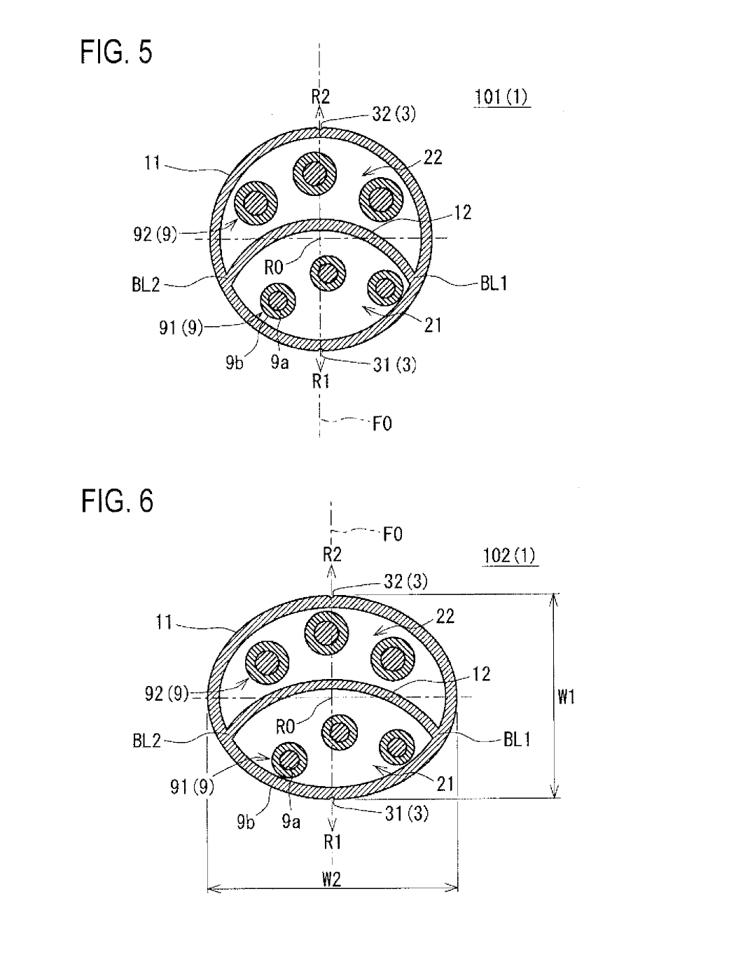

FIG. 5 is a cross-sectional view of the wire harness 10 at the straight pipe portion 101 of the electric-wire protection pipe 1, and FIG. 6 is a cross-sectional view of the wire harness 10 at the bent portion 102 of the electric-wire protection pipe 1.

In the example shown in FIG. 4, the electric-wire protection pipe 1 has a first bent portion 102a and a second bent portion 102b. In the first bent portion 102a, the end surface of the tubular main portion 11 on the first direction R1 side constitutes the inner edge, and the end surface thereof on the second direction R2 side constitutes the outer edge. On the other hand, in the second bent portion 102b, the end surface of the tubular main portion 11 on the second direction R2 side constitutes the inner edge, and the end surface thereof on the first direction R1 side constitutes the outer edge.

As shown in FIGS. 4 to 6, some of the plurality of the insulated electric wires 9 included in the wire harness 10 pass through the first wiring path 21 of the electric-wire protection pipe 1, and the others pass through the second wiring path 22. In the examples shown in FIGS. 4 to 6, three insulated electric wires 9 pass through each of the first wiring path 21 and the second wiring path 22, but the distribution of the insulated electric wires 9 to the two wiring paths 21 and 22 is not limited to this. It is conceivable that the number of the insulated electric wires 9 that pass through each of the two wiring paths 21 and 22 is different. Also, it is conceivable that only one insulated electric wire 9 passes through each of the two wiring paths 21 and 22.

In the wire harness 10, first insulated electric wires 91 that pass through the first wiring path 21 and second insulated electric wires 92 that pass through the second wiring path 22 are different in type. For example, it is conceivable that one of the first insulated electric wire 91 and the second insulated electric wire 92 is an insulated electric wire 9 for a power system and the other is an insulated electric wire 9 for a low-current system (signal system).

As shown in FIGS. 5 and 6, the electric-wire protection pipe 1 is provided with the first wiring path 21 and second wiring path 22 that are surrounded by the metal tubular main portion 11 and the metal curved partition wall 12. These two wiring paths 21 and 22 are surrounded by conductive walls and thus have a shielding function. Moreover, the two wiring paths 21 and 22 have cross-sections with different shapes.

The electric-wire protection pipe 1 is bent, for example, after the insulated electric wires 9 are caused to pass through the two wiring paths 21 and 22. In this case, it is easy to cause the insulated electric wires 9 to pass through the two wiring paths 21 and 22. It should be noted that the electric-wire protection pipe 1 may be bent before the insulated electric wires 9 are caused to pass through the two wiring paths 21 and 22.

As shown in FIGS. 5 and 6, when being bent along the reference plane F0, the tubular main portion 11 and the curved partition wall 12 that constitute the electric-wire protection pipe 1 have no corner portions serving as reinforced portions in the bending direction. Therefore, the tubular main portion 11 and the curved partition wall 12 basically have shapes that are easy to bend along the reference plane F0.

Moreover, as shown in FIG. 6, when the electric-wire protection pipe 1 is bent along the reference plane F0, the tubular main portion 11 is deformed around the axis R0 as substantially a center, and has a cross-section with a flattened shape. At that time, in the tubular main portion 11, a first width dimension W1 in the first direction R1 and the second direction R2 is reduced, and a second width dimension W2 in a direction orthogonal to the axis R0 of the tubular main portion 11 and the first direction R1 is increased. At the same time, the curved partition wall 12 is deformed, reducing its curvature by following the increase in the second width dimension W2 of the tubular main portion 11. That is, the curved partition wall 12 has a structure in which the tubular main portion 11 is unlikely to be prevented from being bent along the reference plane F0.

Furthermore, as shown in FIG. 6, when the curvature of the curved partition wall 12 is reduced and the tubular main portion is caused to have a flattened shape by bending the electric-wire protection pipe 1 along the reference plane F0, the cross-sectional shapes of the two wiring paths 21 and 22 become slightly flattened, but the balance of the cross-sectional areas thereof is not significantly changed.

It should be noted that when the curvature of the curved partition wall 12 is too large, it becomes difficult to bend the curved partition wall 12 along the reference plane F0. Therefore, it is preferable that the curvature of the curved partition wall 12 is set to as a small value as possible within a range in which the tubular main portion 11 is not prevented from being flattened when the electric-wire protection pipe 1 is bent.

Effects

As described above, the electric-wire protection pipe 1 provided with the two wiring paths 21 and 22 that have a shielding function thereinside is provided by using the wire harness 10. Moreover, the ease of bending processing is secured in such an electric-wire protection pipe 1. Furthermore, when the electric-wire protection pipe 1 is used, it is possible to prevent the balance between the cross-sectional areas of the two wiring paths 21 and 22 with shapes different from each other from being significantly changed at the bent portion 102.

When the curved partition wall 12 has symmetry with respect to the reference plane F0 in the electric-wire protection pipe 1, the balance between the cross-sectional areas of the two wiring paths 21 and 22 with shapes different from each other is further prevented from being changed at the bent portion 102.

Moreover, in the electric-wire protection pipe 1, the marks 3 are formed at portions along the lines on which the outer side surface of the tubular main portion 11 and the reference plane F0 intersect with each other. Thereby, the direction suitable for bending the electric-wire protection pipe 1, that is, the direction along the reference plane F0 can be easily confirmed.

Other Considerations

In the electric-wire protection pipe 1, it is conceivable that the tubular main portion 11 has a tubular shape other than a cylindrical shape. For example, it is conceivable that the tubular main portion 11 has a tubular shape that has a cross-section with an oval shape. In the same manner, it is conceivable that the curved partition wall 12 has a cross-section with a shape other than a circular arc shape. For example, it is conceivable that the curved partition wall 12 has a cross-section with an elliptic arc shape.

Moreover, in the electric-wire protection pipe 1, it is conceivable that the marks 3 are formed at portions along the lines on which the outer side surface of the tubular main portion 11 and a plane that passes the axis R0 and is orthogonal to the reference plane F0 intersect with each other.

1-4. (canceled)

5. A wire harness comprising:
a plurality of insulated electric wires; and
an electric-wire protection pipe through which the insulated electric wires pass,
wherein the electric-wire protection pipe comprises:
a tubular main portion that constitutes an outer wall of the electric-wire protection pipe and that has a longitudinal axis, wherein a reference plane passes through the longitudinal axis in a first direction; and
a curved partition wall that connects to the tubular main portion at border lines that are parallel to the longitudinal axis and are located on the first direction side of the longitudinal axis, the curved partition wall having a convex side that projects in a second direction opposite to the first direction, the curved partition wall partitioning a hollow portion of the tubular main portion into a first wiring path on the first direction side and a second wiring path on the second direction side, and
the electric-wire protection pipe has a bent portion that is bent along the reference plane.

6. The wire harness according to claim 5,
wherein the curved partition wall of the electric-wire protection pipe has symmetry with respect to the reference plane.

7. The wire harness according to claim 6,
wherein a mark is formed at a portion along a line at which the outer side surface of the tubular main portion and the reference plane intersect with each other.

8. The wire harness according to claim 6,
wherein a mark is formed at a portion along a line at which the outer side surface of the tubular main portion and a plane that passes the longitudinal axis and is orthogonal to the reference plane intersect with each other.

9. The wire harness according to claim 6,
wherein a mark is formed at a portion along each line at which the outer side surface of the tubular main portion and the reference plane intersect with each other.

10. The wire harness according to claim 6,
wherein a mark is formed at a portion along each line at which the outer side surface of the tubular main portion and a plane that passes the longitudinal axis and is orthogonal to the reference plane intersect with each other.

11. The wire harness according to claim 5,
wherein each one of plurality of electric wires that is in one of the first and second wiring paths is part of a low-current system, and each one of the plurality of electric wires that is in the other of the first and second wiring paths is part of a power system.

12. The wire harness according to claim 5,
wherein the electric-wire protection pipe is a metal pipe.

13. The wire harness according to claim 5,
wherein the convex side of the curved partition wall is located on the second direction side of the longitudinal axis.

14. An electric-wire protection pipe through which insulated electric wires can pass, the electric-wire protection pipe comprising:
a tubular main portion that constitutes an outer wall of the electric-wire protection pipe and that has a longitudinal axis, wherein a reference plane passes through the longitudinal axis in a first direction; and
a curved partition wall that connects to the tubular main portion at border lines that are parallel to the longitudinal axis and are located on the first direction side of the longitudinal axis, the curved partition wall having a convex side that projects in a second direction opposite to the first direction, the curved partition wall partitioning a hollow portion of the tubular main portion into a first wiring path on the first direction side and a second wiring path on the second direction side.

15. The electric-wire protection pipe according to claim 14,
wherein the curved partition wall of the electric-wire protection pipe has symmetry with respect to the reference plane.

16. The electric-wire protection pipe according to claim 14,
wherein a mark is formed at a portion along a line on which the outer side surface of the tubular main portion and the reference plane intersect with each other.

17. The electric-wire protection pipe according to claim 14,
wherein a mark is formed at a portion along a line at which the outer side surface of the tubular main portion and a plane that passes the longitudinal axis and is orthogonal to the reference plane intersect with each other.

18. The electric-wire protection pipe according to claim 14,
wherein a mark is formed at a portion along each line at which the outer side surface of the tubular main portion and the reference plane intersect with each other.

19. The electric-wire protection pipe according to claim 14,
wherein a mark is formed at a portion along each line at which the outer side surface of the tubular main portion and a plane that passes the longitudinal axis and is orthogonal to the reference plane intersect with each other.

20. The electric-wire protection pipe according to claim 14,
wherein a mark is formed at each portion along a line on which the outer side surface of the tubular main portion and the reference plane intersect with each other.

21. The electric-wire protection pipe according to claim 14,
wherein the electric-wire protection pipe is a metal pipe.

22. The electric-wire protection pipe according to claim 14,
wherein the convex side of the curved partition wall is located on the second direction side of the longitudinal axis.
